(19) United States
(12) Patent Application Publication
(10) Pub. No.: US 2016/0226240 A1
(43) Pub. Date: Aug. 4, 2016

(54) CONTROL CIRCUIT AND DEVICE INCLUDING CONTROL CIRCUIT

(71) Applicant: FUJITSU TEN LIMITED, Kobe-shi (JP)

(72) Inventor: Takao SAITO, Kobe-shi (JP)

(73) Assignee: FUJITSU TEN LIMITED, Kobe-shi (JP)

(21) Appl. No.: 15/008,874

(22) Filed: Jan. 28, 2016

(30) Foreign Application Priority Data
Jan. 30, 2015 (JP) 2015-017754

(51) Int. Cl. H02H 9/02

(52) U.S. Cl. CPC H02H 9/02

(57) ABSTRACT

A control circuit includes a current supply, a voltage limitation circuit, a current limitation circuit, and a voltage control stop circuit. The current supply circuit supplies a current to a subject to be controlled. The voltage limitation circuit limits a voltage applied to the subject to be controlled to a predetermined range by controlling the current in the current supply circuit. The current limitation circuit limits the current in the current supply circuit when the current in the current supply circuit is an overcurrent. The voltage control stop circuit stops the voltage limitation circuit to run when the current in the current supply circuit is the overcurrent.

### CROSS-REFERENCE TO RELATED APPLICATION

This application is based upon and claims the benefit of priority of the prior Japanese Patent Application No. 2015-017754, filed on Jan. 30, 2015, the entire contents of which are incorporated herein by reference.

### FIELD

The embodiment discussed herein is related to a control circuit and a device including the control circuit.

### BACKGROUND

Feedback control for approximating the air-fuel ratio that is the ratio of air and fuel in an exhaust gas exhausted from an internal combustion engine to an aimed air-fuel ratio for the purpose of improving vehicle fuel efficiency, etc., is well known, where the air-fuel ratio is detected by an air-fuel ratio sensor (A/F sensor).

For A/F sensors, an A/F sensor that includes a gas sensor element including a pump cell and a detection cell is known. Such an A/F sensor detects, with the detection cell, the voltage corresponding to the difference between the oxygen concentration in a gas detection chamber and a reference oxygen concentration and supplies a current in a direction and a magnitude corresponding to the difference between the detected voltage and a reference voltage to the pump cell (see, for example, Japanese Laid-open Patent Publication No. 2010-096732)

In the above-described A/F sensor, a voltage limitation circuit may be provided in order not to apply an overvoltage to the gas sensor element and a current limitation circuit may be provided to protect the current supply circuit that supplies a current to the gas sensor element.

When the current limitation circuit and the voltage limitation circuit run together, however, there is a risk that the current supply circuit that supplies a current to the gas sensor element fails. The same may happen not only to A/F sensors but also to a control circuit including a current limitation circuit and a voltage limitation circuit and a device including the control circuit.

### SUMMARY

According to an aspect of an embodiment, a control circuit includes a current supply, a voltage limitation circuit, a current limitation circuit, and a voltage control stop circuit. The current supply circuit supplies a current to a subject to be controlled. The voltage limitation circuit limits a voltage applied to the subject to be controlled to a predetermined range by controlling the current in the current supply circuit. The current limitation circuit limits the current in the current supply circuit when the current in the current supply circuit is an overcurrent. The voltage control stop circuit stops the voltage limitation circuit to run when the current in the current supply circuit is the overcurrent.

### BRIEF DESCRIPTION OF DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram illustrating an exemplary configuration of an A/F sensor according to an embodiment of the present invention;

FIG. 2 is a diagram illustrating an exemplary structure of the gas sensor element illustrated in FIG. 1;

FIG. 3 is a diagram illustrating an exemplary relation among the voltage-current conversion amplifier, the current limitation circuit, and the voltage control circuit illustrated in FIG. 1; and

FIG. 4 is a diagram illustrating an exemplary relation between the overcurrent detection circuit and the voltage limitation stop circuit illustrated in FIG. 1.

### DESCRIPTION OF EMBODIMENT

An embodiment of the control circuit and the device including the control circuit disclosed herein will be described in detail below. The embodiment described below is not to be construed as limiting the invention. For example, a gas sensor element is exemplified below as a subject to be controlled; however, the subject to be controlled is not limited to the gas sensor element, and other sensor elements and other elements may be used. A control circuit including a current limitation circuit and a voltage limitation circuit may be applied to a control circuit capable of precisely protecting a current supply circuit and a device including the control circuit.

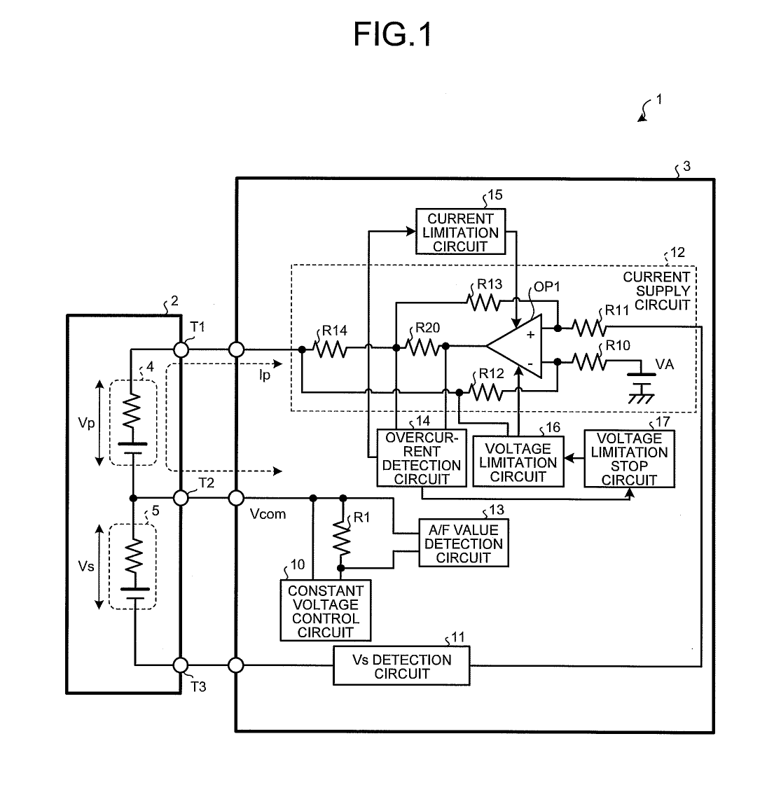

FIG. 1 is a diagram illustrating an exemplary configuration of an A/F sensor according to an embodiment of the present invention. As illustrated in FIG. 1, an A/F sensor 1 includes a gas sensor element 2 and a sensor driver 3 (am exemplary control circuit).

As an exemplary gas sensor element, a gas sensor element including two cells will be described below; however, the gas sensor element is not construed as being limited to a gas sensor element including two cells and, for example, a gas sensor element including a cell or a gas sensor element including three or more cells may be used.

The gas sensor element 2 illustrated in FIG. 1 includes a pump cell 4, a detection cell 5, an IP terminal T1, a COM terminal T2, and a VS terminal T3. The gas sensor element 2 is a universal A/F ratio gas sensor element that is, for example, disposed in an exhaust pipe of an internal combustion engine of a vehicle (not illustrated) and that detects the oxygen concentration (air -fuel ratio) in the exhaust gas.

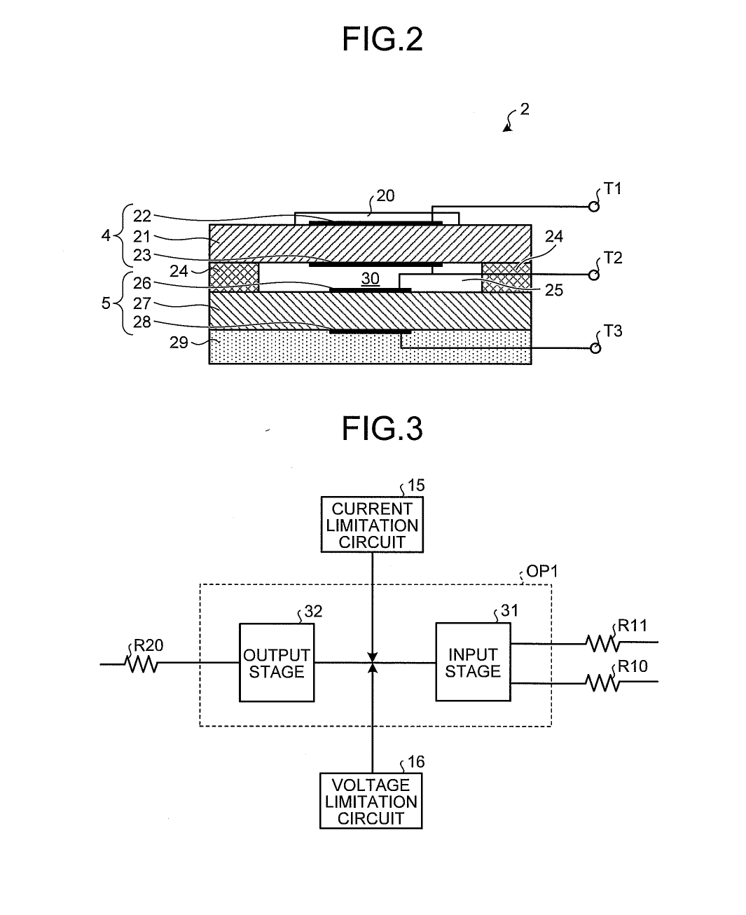

FIG. 2 is a diagram illustrating an exemplary structure of the gas sensor element 2. As illustrated in FIG. 2, the gas sensor element 2 has a structure obtained by sequentially layering a solid electrolyte 21, an insulating base 25, and solid electrolytes 27 and 29.

The solid electrolytes 21, 27 and 29 are solid electrolytes having oxygen ion conductivity and are produced by adding yttria (Y2O3) to zirconia (ZrO2). The insulating base 25 is composed of, for example, alumina.

A gas detection chamber 30 is formed in the insulating base 25, and a porous dispersion regulator 24 that regulates the amount of exhaust gas flowing into the gas detection chamber 30 is provided to both ends of the gas detection chamber 30.

The pump cell 4 includes electrodes 22 and 23 formed of, for example, porous platinum and formed on both surfaces of the solid electrolyte 21 and takes in or draws off oxygen into or from the gas detection chamber 30 according to the magnitude and direction of the current supplied between the electrodes 22 and 23. The electrode 22 is protected with, for example, a porous protective layer 20.

The detection cell 5 includes the solid electrolyte 27 and electrodes 26 and 28 formed of, for example, porous platinum and formed on both surfaces of the solid electrolyte 27. Supplying a constant current between the electrodes 26 and 28 causes an electromotive force corresponding to the oxygen concentration in the gas detection chamber 30 between the electrodes 26 and 28.

The sensor driver 3 illustrated in FIG. 1 will be described here. The sensor driver 3 is implemented with an integrated circuit, such as an application specific integrated circuit (ASIC) or a field programmable gate array (FPGA).

As illustrated in FIG. 1, the sensor driver 3 includes a constant voltage control circuit 10, a Vs detection circuit 11, a current supply circuit 12, an A/F value detection circuit 13, an overcurrent detection circuit 14, and a current limitation circuit 15, a voltage limitation circuit 16, and a voltage limitation stop circuit 17.

The constant voltage control circuit 10 outputs a voltage such that the voltage Vcom at the COM terminal T2 of the gas sensor element 2 is a constant voltage (for example, 3.3 [V]).

The Vs detection circuit 11 includes a constant current source that flows a constant current Icp to the detection cell 5, and flows the constant current Icp from the electrode 28 to the electrode 26 to store oxygen in the constant concentration in the electrode 28. Accordingly, the electromotive force corresponding to the oxygen concentration between the electrodes 26 and 28 occurs between the electrodes 26 and 28 and appears as the voltage Vs across the COM terminal T2 and the VS terminal T3.

The Vs detection circuit 11 detects the voltage Vs across the COM terminal T2 and the terminal T3 (hereinafter, “detected voltage Vs”) and compares the detected voltage Vs and a predetermined reference voltage Vref (for example, 450 [mV]).

The Vs detection circuit 11 outputs a control voltage to the current supply circuit 12 such that the current Ip in a direction and a magnitude corresponding to the difference between the detected voltage Vs and the reference voltage Vref is supplied from the current supply circuit 12 to the IP terminal T1 of the gas sensor element 2.

The current supply circuit 12 includes, for example, a voltage-current conversion amplifier OP1, resistors R10 to R14 and R20, and a constant voltage source VA. The voltage-current conversion amplifier OP1 is, for example, an operational amplifier. The current supply circuit 12 generates a current Ip corresponding to the control voltage that is output from the Vs detection circuit 11 and supplies the current Ip to the IP terminal T1.

When the detected voltage Vs is larger than the reference voltage Vref, the current supply circuit 12 supplies the current Ip to the IP terminal T1 to take in oxygen. When the detection voltage Vs is smaller than the reference voltage Vref, the current supply circuit 12 supplies the current Ip to the IP terminal T1 to draw off oxygen.

The current supply circuit 12 is not limited to the circuit illustrated in FIG. 1, and it suffices if the current supply circuit 12 has a configuration that enables supply of the current Ip according to the control by the Vs detection circuit 11 to the IP terminal T1.

The A/F value detection circuit 13 detects the value of the current Ip flowing into the resistor R1 and calculates the air-fuel ratio (A/F value) based on the value of the current Ip. It suffices if the A/F value detection circuit 13 detects the value of the current Ip and calculates the air-fuel ratio based on the value of the current Ip, i.e., the configuration is not limited to that illustrated in FIG. 1. For example, a resistor may be disposed between the IP terminal T1 and the current supply circuit 12 to detect the current Ip flowing into the resistor.

The overcurrent detection circuit 14 detects whether the current Ip in the current supply circuit 12 is an overcurrent. When the current Ip is over a predetermined value I1, the overcurrent detection circuit 14 determines that the current supply circuit 12 is an overcurrent and outputs a current limitation request to the current limitation circuit 15. According to the example illustrated in FIG. 1, the current supply circuit 12 detects the voltage Vb across the terminals of the resistor R20 disposed between the voltage-current conversion amplifier OP1 and the IP terminal T1 to detect the current Ip (=Vb/R20); however, it suffices if a configuration enabling detection of the current Ip is used.

When the overcurrent detection circuit 14 detects an overcurrent of the current Ip and outputs a current limitation request, the current limitation circuit 15 limits the current Ip in the current supply circuit 12 to be equal to or smaller than a predetermined value I2 (≦I1). Accordingly, the current supply circuit 12 can be prevented from failing due to the overcurrent of the current Ip.

The voltage limitation circuit 16 controls the current Ip in the current supply circuit 12 such that a voltage Vip (=Vp+Vcom) at the IP terminal T1 does not exceed the pressure resistance of the gas sensor element 2 and such that the voltage Vip is limited to a predetermined range Ra (e.g., 3.3±1.2 [V]).

FIG. 3 is a diagram illustrating an exemplary relation among the voltage-current conversion amplifier OP1, the current limitation circuit 15, and the voltage limitation circuit 16. According to the example illustrated in FIG. 3, the voltage-current conversion amplifier OP1 includes an input stage 31 and an output stage 32. The input stage 31 controls the current that is output from the output stage 32 on the basis of the voltage that is input via the resistors R10 and R11.

When the overcurrent detection circuit 14 outputs the current limitation request, the current limitation circuit 15 limits the current that is output from the output stage 32 such that the current Ip in the current supply circuit 12 is equal to or smaller than the predetermined value I2. On the other hand, the voltage limitation circuit 16 controls the current that is output from the output stage 32 such that the voltage Vip is limited to the predetermined range Ra. In this manner, the current limitation circuit 15 and the voltage limitation circuit 16 can independently control the current output from the output stage 32.

FIG. 1 will be referred back here to continue describing the sensor driver 3. When the current Ip is an overcurrent, the voltage limitation stop circuit 17 stops the voltage limitation circuit 16 to run. For example, when the overcurrent detection circuit 14 determines that the current Ip in the current supply circuit 12 is an overcurrent, the voltage limitation stop circuit 17 outputs a voltage limitation stop request to the voltage limitation circuit 16 to stop the voltage limitation circuit 16 to run.

As illustrated above, because the sensor driver 3 stops the voltage limitation circuit 16 to run when the current Ip is an overcurrent, the current Ip in the current supply circuit 12 can be prevented from being an overcurrent. Accordingly, when the current Ip is an overcurrent, the sensor driver 3 can precisely protect the current supply circuit 12. The case where the current Ip is an overcurrent is, for example, the case where the IP terminal T1 and the ground potential (or the power supply potential) are connected with a low resistance.

An exemplary case where an overcurrent is supplied from the current supply circuit 12 to the IP terminal T1 will be described below to describe protection of the current supply circuit 12 that is carried out by stopping the voltage limitation circuit 16 when the current Ip is an overcurrent.

First, a case where the voltage limitation stop circuit 17 is not provided to the sensor driver 3 will be assumed. In this case, when the current Ip in the current supply circuit 12 is equal to or larger than the predetermined value I1, the overcurrent detection circuit 14 determines that the current Ip in the current supply circuit 12 is an overcurrent. The current limitation circuit 15 therefore limits the current Ip in the current supply circuit 12 to be equal to or smaller than the predetermined value Ib.

When the current limitation circuit 15 limits the current Ip, the voltage Vip of the IP terminal T1 lowers, so that the voltage Vip may be output of the predetermined range Ra. In that case, the voltage limitation circuit 16 increases the voltage Vip to the predetermined range Ra to control the current Ip in the current supply circuit 12. Accordingly, the current supply circuit 12 is to supply the current Ip greater than the predetermined value I2, and thus there is a risk that the current Ip in the current supply circuit 12 is an overcurrent and the current supply circuit 12 fails.

On the other hand, as illustrated in FIG. 1, in the case where the voltage limitation stop circuit 17 is provided to the sensor driver 3, the voltage limitation circuit 16 stops running when the overcurrent detection circuit 14 detects an overcurrent of the current Ip and the voltage limitation circuit 16 does not control the current Ip in the current supply circuit 12. Accordingly, the current Ip in the current supply circuit 12 can be prevented from being an overcurrent, which enables precise protection of the current supply circuit 12.

The voltage limitation stop circuit 17 is configured to, when the current Ip is an overcurrent, output a voltage limitation stop request to the voltage limitation circuit 16 before a current limitation request is output from the overcurrent detection circuit 14. Accordingly, the voltage limitation circuit 16 can be stopped to run before the current limitation circuit 15 limits the current Ip.

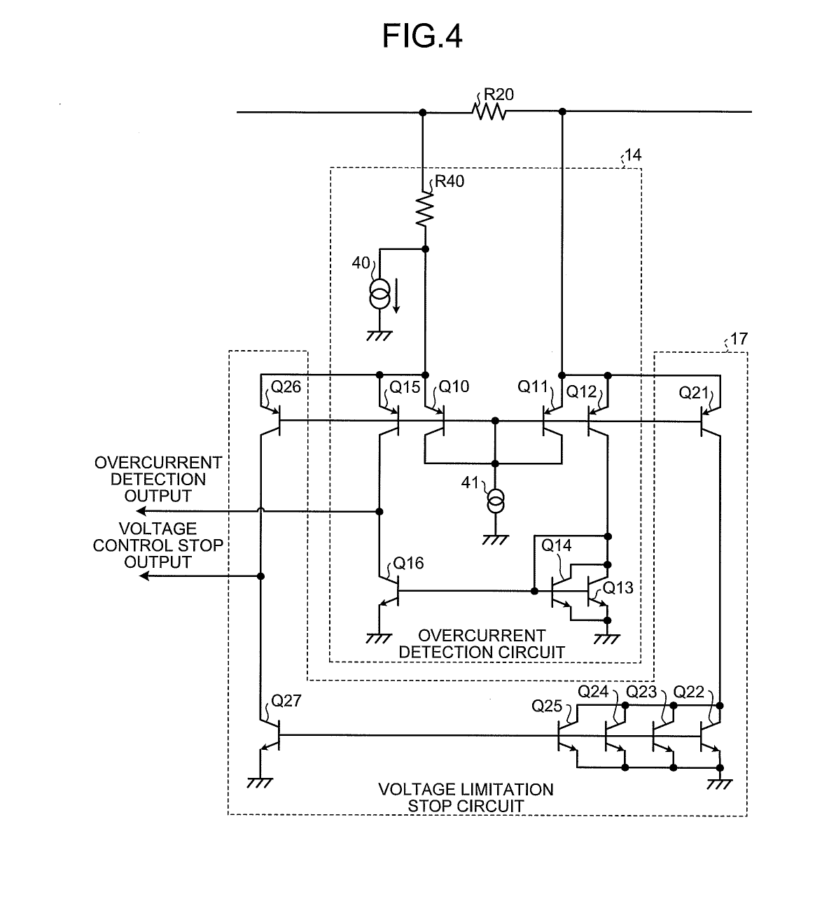

The relation between the overcurrent detection circuit 14 and the voltage limitation stop circuit 17 will be described here. FIG. 4 is a diagram illustrating an exemplary relation between the overcurrent detection circuit 14 and the voltage limitation stop circuit 17.

The overcurrent detection circuit 14 illustrated in FIG. 4 takes the voltage across the terminals of the resistor R20 as a differential input and, when the current flowing into the resistor R20 is equal to or larger than the predetermined value I1, carries out an overcurrent detection output (an exemplary current limitation request).

The overcurrent detection circuit 14 includes a resistor R40, transistors Q10 to Q16, and a constant current sources 40 and 41. When the voltage across the terminals of the resistor R20 is larger than the voltage across the terminals of the resistor R40, the overcurrent detection circuit 14 carries out an overcurrent detection output. Note that the transistors Q10 and Q11 and the constant current source 41 configure, for example, an input stage and the transistors Q12 to Q16 configure, for example, an output stage.

The voltage limitation stop circuit 17 includes transistors Q21 to Q27 and takes the voltage across the terminals of the resistor R20 as a differential input. When the current flowing into the resistor R20 is equal to or larger than a predetermined value I3 (<I1), the voltage limitation stop circuit 17 carries out a voltage control stop output (exemplary voltage limitation stop request).

The current mirror circuit of the voltage limitation stop circuit 17 illustrated in FIG. 4 is different from that of the overcurrent detection circuit 14 in that, while there are two parallel connections (transistors Q13 and Q14) on one side (non-output side) of the current mirror circuit of the overcurrent detection circuit 14, there are four parallel connections (transistors Q22 to Q25) on the other side (non-output side).

The difference in the number of connections causes a difference in detection sensitivity between the overcurrent detection circuit 14 and the voltage limitation stop circuit 17, and the voltage limitation stop circuit 17 carries out a voltage control stop output even when the current Ip is lower than the predetermined value I1. Accordingly, when the current flowing into the resistor R20 is equal to or larger than the predetermined value I1, the voltage limitation stop circuit 17 can carry out a voltage control stop output before the overcurrent detection circuit 14 carries out an overcurrent detection output.

As described above, the voltage limitation stop circuit 17 illustrated in FIG. 4 carries out a voltage control stop output according to the state of the input stage of the overcurrent detection circuit 14, which enables size reduction. Furthermore, because the voltage limitation stop circuit 17 has a configuration obtained by increasing the number of parallel stages of transistors on one side of the overcurrent detection circuit 14, a precise voltage control stop output is enabled before an overcurrent detection output.

The overcurrent detection circuit 14 may be used as the voltage limitation stop circuit 17. In this case, the overcurrent detection circuit 14 outputs a voltage limitation stop request upon determining that the current Ip in the current supply circuit 12 is an overcurrent, and the voltage limitation circuit 16 stops running to limit the voltage when the voltage limitation stop request is issued.

According to the example illustrated in FIG. 4, the difference in detection sensitivity is provided between the overcurrent detection circuit 14 and the voltage limitation stop circuit 17 by the number of parallel connections of transistors. Alternatively, the detection sensitivity difference may be provided by the size of transistor.

The embodiment of the invention has been described according to the accompanying drawings; however, they are exemplary only and the invention may be carried out in various modes in which modification and improvement are made according to the knowledge of those skilled in the art, including the mode described in the summary section.

The control circuit and the device including the control circuit device according to the embodiment are efficiently used in, for example, controlling combustion and exhaust of vehicle and is suitable for feedback control of fuel supply volume corresponding to the concentration of a specific gas in exhaust gas.

What is claimed is:

1. A control circuit comprising:
a current supply circuit that supplies a current to a subject to be controlled;
a voltage limitation circuit that limits a voltage applied to the subject to be controlled to a predetermined range by controlling the current in the current supply circuit;
a current limitation circuit that limits the current in the current supply circuit when the current in the current supply circuit is an overcurrent; and
a voltage control stop circuit that stops the voltage limitation circuit to run when the current in the current supply circuit is the overcurrent.

2. The control circuit according to claim 1, wherein
the voltage limitation circuit supplies a current to an output stage of the current supply circuit to limit the voltage to a predetermined range, and
when the current in the current supply circuit is the overcurrent, the current limitation circuit supplies a current to the output stage to limit the current in the current supply circuit.

3. The control circuit according to claim 1, further comprising an overcurrent detection circuit that outputs a current limitation request to the current limitation circuit when the current in the current supply circuit is the overcurrent,
wherein
the current limitation circuit limits the current when the current limitation request is issued,
when the current in the current supply circuit is the overcurrent, the voltage control stop circuit outputs a voltage limitation stop request to the voltage limitation circuit before the overcurrent detection circuit outputs the current limitation request, and
when the voltage limitation stop request is issued, the voltage limitation circuit stops running to limit the voltage to the predetermined range.

4. The control circuit according to claim 2, further comprising an overcurrent detection circuit that outputs a current limitation request to the current limitation circuit when the current in the current supply circuit is the overcurrent,
wherein
the current limitation circuit limits the current when the current limitation request is issued,
when the current in the current supply circuit is the overcurrent, the voltage control stop circuit outputs a voltage limitation stop request to the voltage limitation circuit before the overcurrent detection circuit outputs the current limitation request, and
when the voltage limitation stop request is issued, the voltage limitation circuit stops running to limit the voltage to the predetermined range.

5. The control circuit according to claim 1, wherein the subject to be controlled is a gas sensor element.

6. A device comprising the control circuit according to claim 1.
